(19) United States
(12) Patent Application Publication
(10) Pub. No.: US 2013/0282449 A1
(43) Pub. Date: Oct. 24, 2013

(54) METHOD AND APPARATUS FOR THE GENERATION OF VIRTUAL GOODS WITH RANDOMIZED VALUE ELEMENTS

(71) Applicants: Lawrence P. Gouett, Millbrook (CA); Juan C. Murillo, San Juan (CR)

(72) Inventors: Lawrence P. Gouett, Millbrook (CA); Juan C. Murillo, San Juan (CR)

(21) Appl. No.: 13/453,088

(22) Filed: Apr. 23, 2012

(51) Int. Cl. G06Q 30/02

(52) U.S. Cl. 705/14.1

(57) ABSTRACT

A computer-implemented method for generating virtual goods, including storing computer readable instructions in a memory element for at least one computer, and executing, using a processor for the at least one computer, the computer readable instructions to generate a randomized value element in accordance with a set of generation rules; assign the randomized value element to a first virtual good; and, transmit a first representation of the first virtual good for display. A computer-based apparatus for generating of virtual goods with randomized value elements, including a memory element for at least one computer arranged to store computer readable instructions, a processor for the at least one computer, arranged to execute the computer readable instructions to generate a randomized value element in accordance with a set of generation rules; assign the randomized value element to a first virtual good; and, transmit a first representation of the first virtual good for display.

### BACKGROUND

Virtual goods are non-physical items that are created and exchanged in computer-implemented settings, such as online games or communities. Virtual goods are usually represented by an image, movie, 3-dimensional model, or other media file, and generally have no tangible presence outside of the computer-implemented setting in which they exist. As they are intangible, virtual goods are not subject to scarcity or other limitations of physical goods. For example, virtual goods can be created, destroyed, or copied trivially, they can have functionality unrelated to their representation in the computer-implemented setting, and they can be transferred instantly between parties. Virtual goods feature prominently in many computer-implemented settings, and many users of these settings spend significant amounts of time obtaining, trading, and/or modifying virtual goods.

While virtual goods can be obtained as part of normal user interaction in a computer-implemented setting, many virtual goods are obtainable only in transactions that require virtual or actual currency. Generally, these types of virtual goods are created by processes within the computer-implemented setting, as opposed to by users of the setting. In this way, the operators of the computer-implemented setting have control over the virtual goods that are generated. While individual virtual goods purchase transactions may not be for large amounts of actual currency, the quantity of these transactions have created a sizable market for virtual goods. For example, in 2010, 7.3 billion dollars (USD) was spent, worldwide, on virtual goods. Many online games and communities are funded solely through the sale of virtual goods. Therefore, it is vital that the users of these games and communities continuously buy virtual goods.

One way in which the operators of computer-implemented settings can increase demand for virtual goods is by limiting the number of virtual goods of a type that are created. Operators may also add attributes to virtual goods that impart some benefit on the user. In many computer-implemented settings, users are represented by virtual depictions called avatars. As an example of a benefit that a virtual good may impart on a user, a virtual pair of shoes may allow a user's avatar in a game to walk faster than normal. However, once a user has purchased these types of virtual goods, there is no incentive to purchase others of the same type, as the user already knows exactly what they will be receiving, and no further benefit may be gained by having more than one virtual good of the same type.

Thus, there is a need for a type of virtual goods and a method of generating the same that has continuous appeal to users and purchasers of virtual goods.

### SUMMARY

According to aspects illustrated herein, there is provided a computer-implemented method for generating virtual goods, including storing computer readable instructions in a memory element for at least one computer, and executing, using a processor for the at least one computer, the computer readable instructions to generate a randomized value element in accordance with a set of generation rules; assign the randomized value element to a first virtual good; and, transmit a first representation of the first virtual good for display.

According to other aspects illustrated herein, there is provided a computer-based apparatus for generating of virtual goods with randomized value elements, including a memory element for at least one computer arranged to store computer readable instructions, and a processor for the at least one computer, arranged to execute the computer readable instructions to generate a randomized value element in accordance with a set of generation rules; assign the randomized value element to a first virtual good; and, transmit a first representation of the first virtual good for display.

Other objects, features and advantages of one or more embodiments will be readily appreciable from the following detailed description and from the accompanying drawings and claims.

### BRIEF DESCRIPTION OF THE DRAWINGS

Various embodiments are disclosed, by way of example only, with reference to the accompanying drawings in which corresponding reference symbols indicate corresponding parts, in which:

FIG. 1 is a flowchart detailing the individual steps in an embodiment of the virtual good generation method;

FIG. 2a is an illustration of an embodiment of a virtual good prior to purchase with the randomized value element fully hidden;

FIG. 2b is an illustration of an embodiment of the virtual good of FIG. 2a after purchase with the randomized value element partially revealed;

FIG. 2c is an illustration of an embodiment of the virtual good of FIG. 2a after purchase with the randomized value element fully revealed;

FIG. 3a is an illustration of an embodiment of a custom virtual good generation interface;

FIG. 3b is an illustration of an embodiment of a custom-generated virtual good;

FIG. 4 is an illustration of an embodiment of a virtual good that is arranged to be transferred to a third party;

FIG. 5a is an illustration of an embodiment of a virtual good prior to reloading; and,

FIG. 5b is an illustration of an embodiment of the virtual good of FIG. 5a after reloading.

### DETAILED DESCRIPTION

At the outset, it should be appreciated that like drawing numbers on different drawing views identify identical, or functionally similar, structural elements of the embodiments set forth herein. Furthermore, it is understood that these embodiments are not limited to the particular methodology, materials and modifications described and as such may, of course, vary. It is also understood that the terminology used herein is for the purpose of describing particular aspects only, and is not intended to limit the scope of the disclosed embodiments, which are limited only by the appended claims.

Unless defined otherwise, all technical and scientific terms used herein have the same meaning as commonly understood to one of ordinary skill in the art to which these embodiments belong. As used herein, “computer,” “personal computer,” or “computing device” is generally meant to include any analog or digital electronic device which comprises a processor, memory, and/or a storage medium for operating or executing software or computer code, e.g., desktop computer, laptop computer, smart phone, tablet computer, etc. Furthermore, “virtual good” or “virtual goods” is meant to include any type of non-physical item that is created and exchanged in a computer-implemented setting. Moreover, “random,” “randomly,” or “randomized” is generally meant to include any values that have been generated in a non-deterministic fashion using any of the methods well known in the art.

Although any methods, devices or materials similar or equivalent to those described herein can be used in the practice or testing of these embodiments, some embodiments of methods, devices, and materials are now described.

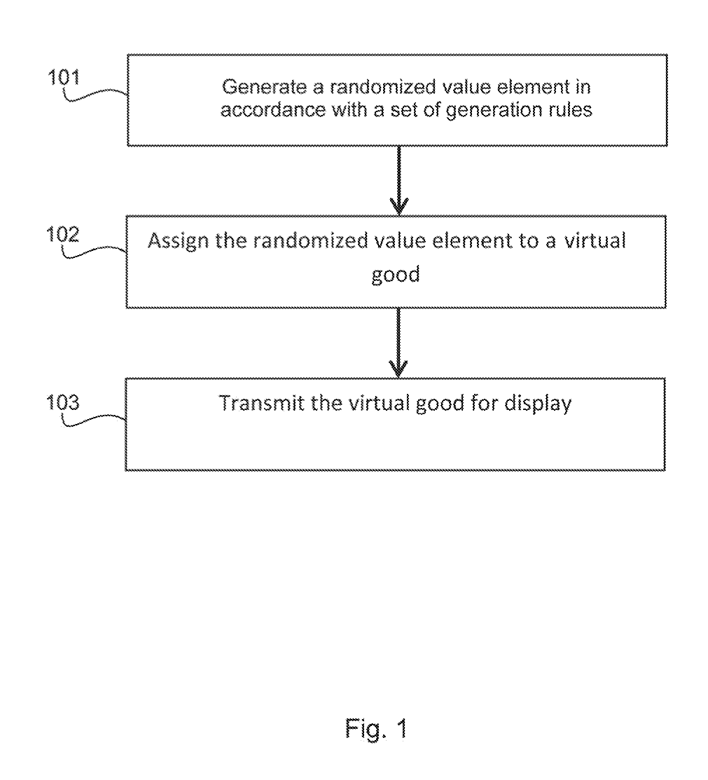

Referring now to the figures, FIG. 1 shows a series of steps, represented as a flowchart, comprising the steps of generating a randomized value element in accordance with a set of generation rules 101, assigning the randomized value element to a virtual good 102, and transmitting the virtual good for display 103. Generating a randomized value element in accordance with a set of generation rules 101 results in a randomized value element that can be assigned to a virtual good. Broadly, this generation of a randomized value element using the generation rules results in a value element that comprises one or more of each of a quantity and type. For example, generating a randomized value element may result in a randomized value element that comprises a prize of 25 virtual coins, wherein the quantity element is 25 and the type is virtual coins. However, due to the random nature of the generation process, generating a randomized value element in accordance with the same rules may result in a value element that comprises a prize of 25 virtual coins and a multiplier of 4, resulting in a total prize of 100 virtual coins. In this instance, there are two quantity elements, 25 and 4, and two types, virtual coins and a multiplier. The randomized value element generated in this way may also comprise 5 free reloads, which are discussed infra, or an invitation to a special online game, or a t-shirt or other actual goods, actual cash prizes, or a combination of the above. It will be appreciated that because the generation rules can be created to allow for prizes of any type and any quantity, including virtual and non-virtual goods and currency, application of the generation rules can result in a randomized value element comprising essentially anything. It should be further appreciated that the foregoing examples are used to merely illustrate how step 101 may occur; however, such examples are not intended to limit the scope of the claimed invention.

The step of assigning the randomized value element to the virtual good 102 comprises associating the selected virtual good with the randomized value element generated through the generation of the randomized value element in accordance with the set of generation rules 101. This may comprise adding computer readable instructions to the data comprising the virtual good, such that receiving the prize contained in the randomized value element automatically applies the prize to an account or value repository. It may also comprise including a reference, in the form of a code, hyperlink, or equivalent that can be used to contact an external computer or system to receive the prize contained in the randomized value element. It may further comprise adding computer readable instructions to the data comprising the virtual good, such that the virtual good has additional functionality, such as acting as an invitation to a special online game, or permitting a recipient of the virtual good to reload other virtual goods for free. It may additionally comprise a code or other data that can be redeemed for receipt of non-virtual goods, such as a t-shirt or coffee mug.

The step of transmitting the virtual good for display 103 comprises transmitting the data and computer readable instructions that comprise the virtual good with randomized value element to a computer output device, such as a monitor, on which the virtual good can be viewed, or a remote computer, on which the virtual good can be stored. The assigned randomized value element may not be initially displayed on the computer output device, or may only be displayed in part. The full display of the randomized value element may not occur until some other triggering action, such as the receipt of an offer to purchase the virtual good. The many ways in which data and computer readable instructions can be transmitted and the many types of computer output devices will be readily appreciated by those of ordinary skill in the art.

It should be appreciated that the virtual good that is assigned the randomized value element can be randomly selected from all possible virtual goods or a list of specific virtual goods, selected by receiving an input that indicates a specific virtual good, or by selecting the next available virtual good from a list of virtual goods. The virtual good may also be selected from a time-dependent list of virtual goods, such that during a specified time period, only certain quantities and types of virtual goods may be selected at random, or from a quantity-limited list of virtual goods, such that only a limited number of each available type of virtual good is available to be selected, with each selection of a type of virtual good decrementing the available amount. Since virtual goods do not have an inherent visual form, each virtual good is given a representation, which may include but is not limited to an image, a movie, or a 3-dimensional model that serves to visually identify the virtual good.

The generation rules in the step of generating a randomized value element in accordance with a set of generation rules 101 may include multiple ways of generating randomized value elements, and may also include different types of randomized value elements. For example, randomized value elements may be generated by random selection from all possible value elements or a list of specific value elements. Generation rules may also include time-dependent generation rules, such that during a specified time period, only certain quantities and types of randomized value elements may be available, to be selected at random, or quantity-limited generation rules, such that only a limited quantity of each available type of randomized value element is available to be assigned to a virtual good, with each assignment of a type of randomized value element decrementing the available amount. Additionally, more than one type of generation rule may be applied during the step of generating a randomized value element in accordance with a set of generation rules 101. As an example, application of the generation rules may generate a randomized value element that comprises a sum of virtual coins, chosen by random selection from all types of prizes. The randomized value element may further comprise a quantity element of 10,000, which, because the randomized value element was generated on the second Tuesday of the month, was chosen at random from the “second Tuesday of the month” list of quantity elements. This quantity element is then applied to the virtual coins generated previously, resulting in a randomized element of 10,000 virtual coins. The randomized value element may further comprise an invitation to a special chat room, which was chosen from a quantity of 2,000 chat room invitations. Whenever an invitation is chosen from this quantity by the generation rules, the total number of available invitations is decremented, such that only 2,000 invitations may be issued, in total. Therefore, for the purposes of this example, application of the generation rules generated a randomized value element comprising 10,000 virtual coins and an invitation to a special chat room.

Optionally, as part of the foregoing steps, a unique identifier can be generated and assigned to the virtual good. This unique identifier, which may comprise a sequential number or hashed value, can be used to identify and track the virtual good.

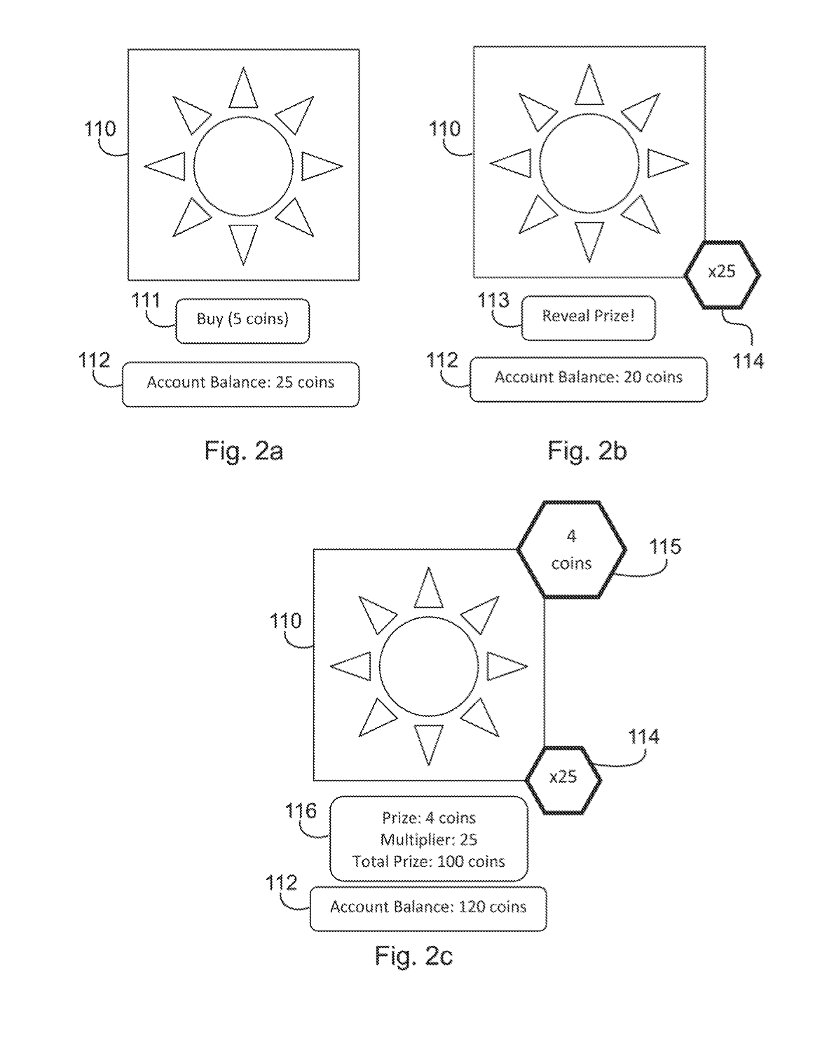

FIG. 2a is an illustration of an embodiment of the invention showing virtual good 110 and interface components 111 and 112 that have been transmitted and displayed on a user's computer monitor. Virtual good 110 has a randomized value element, which in this embodiment, is hidden prior to the user purchasing the virtual good. Interface component 111 is a button that both displays the cost to purchase virtual good 110 and actually purchases virtual good 110 when actuated. Interface component 112 is an indicator that displays the amount of “coins” the user has remaining, where coins in this embodiment are the virtual currency used to purchase virtual goods. In this embodiment, purchasing virtual good 110 would remove 5 coins from the user's account, leaving 20 coins in the account.

FIG. 2b is an illustration of an embodiment of the invention showing virtual good 110 and interface components 112, 113 and 114 that have been transmitted and displayed on a user's computer monitor immediately after the purchase by a user of virtual good 110. The purchase of virtual good 110 has removed 5 coins from the user's account, which is reflected by the reduced account balance in interface element 112 over the account balance shown in FIG. 2a. The act of purchasing virtual good 110 has revealed part of the randomized value element, namely, the 25 multiplier, as indicated by interface component 114. Interface component 113 can be actuated to reveal the remaining components of the randomized value element assigned to virtual good 110.

FIG. 2c is an illustration of an embodiment of the invention showing virtual good 110 and interface components 112, 114, 115 and 116 that have been transmitted and displayed on a user's computer monitor immediately after the remaining components of the randomized value element of virtual good 110 have been revealed. In this embodiment, interface component 115 indicates that the prize element of virtual good 110 is 4 coins. This prize element, when multiplied by the 25 multiplier, indicated by interface component 114, yields 100 coins. This result is described in interface component 116, and the coins received from the randomized value element are immediately added to the user's account balance, as evidenced by the change in interface component 112. It will be appreciated that some types of randomized value elements, such as invitations and non-virtual goods, may not be added to the user's account immediately, but instead may be redeemed at a later time. Furthermore, it should be appreciated that the foregoing examples are for illustration purposes only and that other embodiments may also occur, such as a slider, a lever or a physical button may be used as interface component 111, and such variations are within the spirit and scope of the claimed invention.

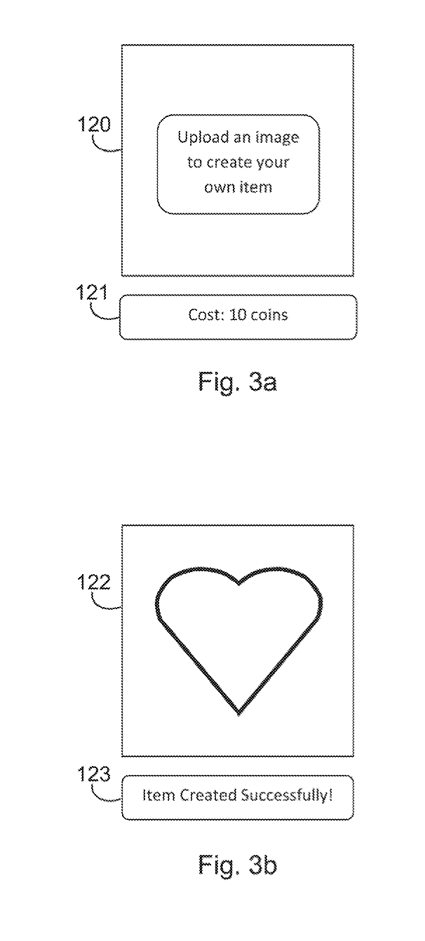

FIG. 3a is an illustration of an embodiment of the invention that has been transmitted and displayed on a user's computer monitor that shows the custom selection and creation of a custom virtual good. Interface component 120, when actuated, allows a user to upload an image or other media file, including movies or 3-dimensional models, to create a new virtual good. Interface component 121 indicates the cost, in coins for example, to create a custom virtual good.

FIG. 3b is an illustration of an embodiment of the invention that shows an embodiment of custom virtual good 122 that has been transmitted and displayed on a user's computer monitor immediately after creation. Custom virtual good 122 has a randomized value element which was generated in accordance with the applicable generation rules, and which is currently hidden. Interface component 123 informs the user that custom virtual good 122 has been created successfully, including the assignment of a randomized value element.

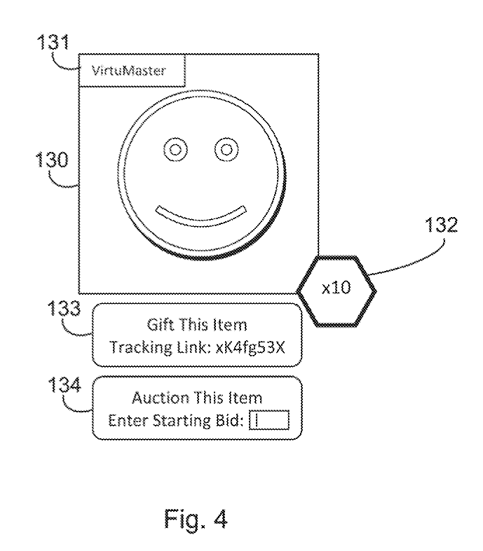

FIG. 4 is an illustration of an embodiment of the invention that shows virtual good 130 that has been transmitted and displayed on a user's computer monitor. Virtual good 130 has branding element 131 incorporated into its representation, so that it is immediately apparent that “VirtuMaster” is the origin of virtual good 130. Interface component 132 indicates that the multiplier element of the randomized value element of the second virtual good 130 is 10.

Interface component 133 indicates that it is possible to gift virtual good 130 to a third party by sharing the tracking link displayed in interface component 133. By receiving this tracking link and inputting it into a separate interface component, which is not shown, ownership of virtual good 130 is transferred to the third party. In an alternate embodiment, the tracking link displayed in interface component 133 may be substituted by a hyperlink or similar mechanism which allows third parties to actuate the hyperlink or similar mechanism and automatically transfer ownership of virtual good 130. In yet another embodiment, transfer of ownership of virtual good 130 may be effected by other interface means, such as dragging the representation of virtual good 130 from a representation of a first user's inventory to a representation of a second user's inventory. All of the foregoing embodiments may be accompanied by a contemporaneous exchange of virtual currency or goods, such that the gift transaction is transformed into a purchase transaction or barter transaction, or alternatively, a contemporaneous exchange of non-virtual currency or goods, such as a monetary transaction through a credit card service.

Interface element 134 indicates that it is possible to auction virtual good 130 such that the representation of virtual good 130 will be displayed, along with a starting bid, and third parties may place bids in excess of the existing bid. The auction process will continue until a pre-designated time limit or other event is reached. The third party with the highest bid at the end of the auction process will receive ownership of virtual good 130.

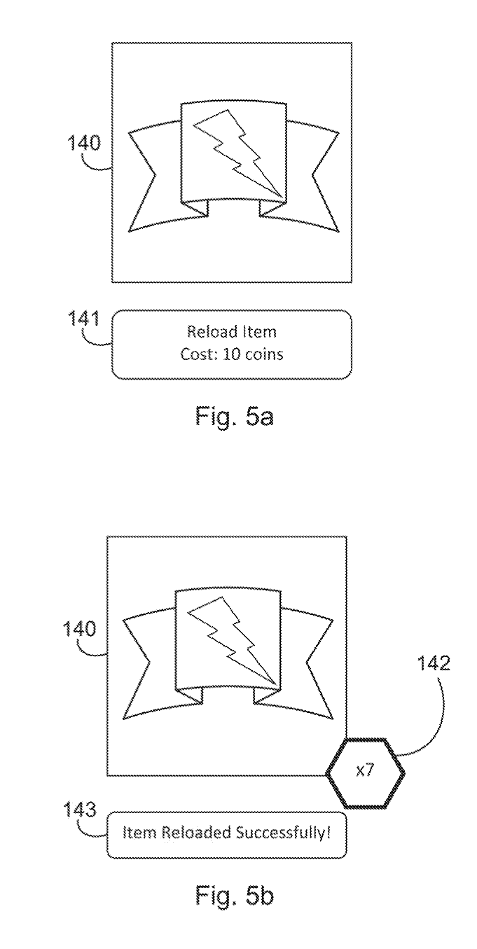

FIG. 5a is an illustration of an embodiment of the invention that shows virtual good 140 that has been transmitted and displayed on a user's computer monitor. In this figure, virtual good 140 has no randomized value element. This absence of a randomized value element may have resulted from the previous revealing and/or redemption of a randomized value element that had been assigned to virtual good 140, or because no randomized value element has been assigned to virtual good 140. interface component 141 indicates that virtual good 140 can have a new randomized value element generated and assigned to it. This process is called reloading, and interface component 141 indicates that it will cost the user 10 coins to reload virtual good 140. The reloading process applies a set of generation rules to generate a randomized value element, and then assigns the randomized value element to the virtual good to be reloaded. In this way, the reloading process only differs from the creation of a new virtual good with a randomized value element in that in uses an extant virtual good.

FIG. 5b is an illustration of an embodiment of the invention showing virtual good 140 displayed on a user's computer monitor immediately after the reloading process.

Interface component 142 indicates that the now-reloaded virtual good 140 has a randomized value element that includes a multiplier of 7. Other components of the randomized value element remain hidden. Interface component 143 indicates that virtual good 140 has been successfully reloaded.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-implemented method for generating virtual goods, comprising:
storing computer readable instructions in a memory element for at least one computer; and,
executing, using a processor for said at least one computer, said computer readable instructions to:
generate a randomized value element in accordance with a set of generation rules;
assign said randomized value element to a first virtual good; and, transmit a first representation of said first virtual good for display.

2. The method recited in claim I wherein generating said randomized value element comprises generating a prize element and a multiplier element.

3. The method recited in claim I wherein said representation of said first virtual good comprises:
an indication that said randomized value element is assigned to said first virtual good; and,
a description of at least a portion of said randomized value element.

4. The method recited in claim I wherein said representation of said first virtual good comprises:
an indication that said randomized value element is assigned to said first virtual good; and,
a message that a description of said randomized value element will be revealed upon receipt of an offer to purchase said first virtual good, said method further comprising executing, using said processor, said computer readable instructions to:
receive an offer to purchase said first virtual good; and,
in response to receipt of said offer to purchase:
transmit a second representation of said first virtual good including said randomized value element; or,
transmit a third representation including a user selectable option for revealing said randomized value element.

5. The method recited in claim 1 wherein said randomized value element is selected from the group consisting of: at least one second virtual good, at least one invitation, at least one non-virtual good, a virtual currency, a non-virtual currency, and combinations thereof.

6. The method recited in claim 1 further comprising executing, using said processor, said computer readable instructions to associate a unique identifier with said first virtual good.

7. The method recited in claim 1 further comprising executing, using said processor, said computer readable instructions to: accept an offer to buy said first virtual good, wherein generating a randomized value element in accordance with said set of generation rules comprises generating said randomized value element in accordance with a second set of generation rules after said offer is accepted.

8. The method recited in claim 1 wherein said set of generation rules comprises at least one time-related limitation on the availability of a randomized value element.

9. The method recited in claim 1 further comprising executing, using said processor, said computer readable instructions to:
generate a reference to said first virtual good; and,
associate said reference to said first virtual good with said first virtual good.

10. The method recited in claim I further comprising executing, using said processor, said computer readable instructions to: associate an indicator of origin with said virtual good.

11. The method recited in claim I further comprising executing, using said processor, said computer readable instructions to: generate a predetermined number of the first virtual good.

12. The method recited in claim 1 further comprising executing, using said processor, said computer readable instructions to: prepare said first virtual good to be transferred to a third party.

13. The method recited in claim 1 further comprising executing, using said processor, said computer readable instructions to: transfer said first virtual good via an auction process or via attachment to a message.

14. The method recited in claim 13 wherein transferring said first virtual good. via said auction process comprises transferring said first virtual good via purchase with a virtual currency.

15. A computer-based apparatus for generating of virtual goods with randomized value elements, comprising:
a memory element for at least one computer arranged to store computer readable instructions; and,
a processor for said at least one computer, arranged to execute said computer readable instructions to:
generate a randomized value element in accordance with a set of generation rules;
assign said randomized value element to a first virtual good; and, transmit a first representation of said first virtual good for display.

16. The apparatus recited in claim 15 wherein generating said randomized value element comprises generating a prize element and a multiplier element.

17. The apparatus recited in claim 15 wherein said representation of said first virtual good comprises:
an indication that said randomized value element is assigned to said first virtual good; and,
a description of at least a portion of said randomized value element.

18. The apparatus recited in claim 15 wherein:
said representation of said first virtual good comprises:
an indication that said randomized value element is assigned to said first virtual good; and,
a message that a description of said randomized value element will be revealed upon receipt of an offer to purchase said first virtual good; and,
said processor is arranged to execute said computer readable instructions to:
receive an offer to purchase said first virtual good; and,
in response to receipt of said offer to purchase:
transmit a second representation of said first virtual good including said randomized value element; or,
transmit a second representation including a user selectable option for revealing said randomized value element.

19. The apparatus recited in claim 15 wherein said randomized value element is selected from the group consisting of: at least one second virtual good, at least one invitation, at least one non-virtual good, a virtual currency, a non-virtual currency, and combinations thereof

20. The apparatus recited in claim 15 wherein said processor is arranged to execute said computer readable instructions to: associate a unique identifier with said first virtual good.

21. The apparatus recited in claim 15 wherein:
said processor is arranged to execute said computer readable instructions to: accept an offer to buy said first virtual good; and, generating a randomized value element in accordance with said set of generation rules comprises generating said randomized value element in accordance with a second set of generation rules after said offer is accepted.

22. The apparatus recited in claim 15 wherein said set of generation rules comprises a set of time-dependent limitations on randomized value element generation.

23. The apparatus recited in claim 15 wherein said processor is arranged to execute said computer readable instructions to:
generate a reference to said first virtual good; and,
associate said reference to said first virtual good with said first virtual good.

24. The apparatus recited in claim 15 wherein said processor is arranged to execute said computer readable instructions to associate an indicator of origin with said first virtual good.

25. The apparatus recited in claim 15 wherein said set of generation rules comprises a limit on the number of virtual goods that can be generated.

26. The apparatus recited in claim 15 wherein said processor is arranged to execute said computer readable instructions to prepare said first virtual good to be transferred to a third party.

27. The apparatus recited in claim 15 wherein said processor is arranged to execute said computer readable instructions to transfer said first virtual good via an auction process or via attachment to a message.

28. The apparatus recited in claim 27 wherein transferring said first virtual good via said auction process comprises transferring said virtual good via purchase with a virtual currency.
